(19) United States
(12) Patent Application Publication
(10) Pub. No.: US 2003/0018907 A1
(43) Pub. Date: Jan. 23, 2003

(54) Content protection for digital media

(75) Inventors: Trung V. Le, White Bear Township, MN (US); Roger C. Culhane, Stillwater, MN (US)

Correspondence Address: Imation Corp., Attention: Eric D. Levinson, Legal Affairs, P.O. Box 64898, St. Paul, MN, 55164-0898, US

(73) Assignee: Imation Corp.

(21) Appl. No.: 09/907,230

(22) Filed: Jul. 17, 2001

(51) Int. Cl. G06F 11/30; G06F 12/14

(52) U.S. Cl. 713/190

(57) ABSTRACT

In general, the invention allows for content protection of digital data by intentionally introducing errors introduced within error correction information during the production or generation of an original digital medium, or any authorized copy thereof The errors may be introduced within error correction information corresponding to the stored content, such as a software application, audio or video file, or within a stored “access key” used to access the content. The errors may be introduced, for example, at the time of manufacturing of the medium or when making an authorized copy of digital data. When authenticating digital media, the erroneous error correction information is disregarded and corresponding “raw” uncorrected data is used for authentication purposes.

### TECHNICAL FIELD

The invention relates to digital storage media and, more particularly, to protecting digital media.

### BACKGROUND OF THE INVENTION

A wide variety of data storage devices exist for storing digital data, including magnetic cassettes, magnetic tape, magnetic disks, magneto-optical and optical storage devices, such as compact disks (CDs) and digital video discs (DVD). CDs typically contain either digital audio information, such as music, or computer programs. While a large amount of information can be contained on a CD, the amount of information contained on a DVD is larger yet. In addition to containing more information, DVDs are a faster medium for holding video information along with audio information and computer programs.

Optical disks store digital data along spiral grooves on the disk. These grooves can contain billions of “pits” and “lands” that represent the digital data. A laser “stylus” is used to read these pits and lands to extract the data from the disk. Data read from a disk can be copied to any number of storage medium. For example, data contained on one optical disk could be copied and stored to a second optical disk. This can be accomplished, for example, by recording the data to a CD-R (recordable) disc. The CD-R disc has a layer of optically active dye that reacts when exposed to a recording laser to form pits on the recordable disk. Therefore, it is possible to copy the content of one CD to as many CDs as a person would like.

Different approaches have been taken in an effort to prevent the unauthorized copying of the digital data from one storage device to another. One approach has been to embed “watermarks” within the digital data. Watermarks insert information, such as a number or text, into the media data through a slight modification of the data. The purpose of the watermarks is to assist in copyright protection, labeling, monitoring and allowing for conditional access to the media data. Additional approaches to preventing unauthorized use include requiring a valid license code or serial number before any digital data, such as a software application, can be installed or executed.

### SUMMARY OF THE INVENTION

In general, the invention allows for content protection of digital data. More specifically, the techniques described herein allow authorized copies of digital medium to be read and used with a computer system, but automatically corrupts the data to prevent the creation of a functional unauthorized copy of the medium. The techniques make use of error correction and detection schemes commonly found in conventional data storage devices. As a result, the techniques can be used with existing input/output systems and driver software. As a result, content protection of digital medium can be achieved using currently existing computer devices.

In order to prevent the unauthorized copying of digital media, errors are intentionally introduced within the error correction information during the production or generation of the original digital medium, or any authorized copy thereof The errors may be introduced within error correction information corresponding to the stored content, such as a software application, or within a stored “access key” used to access the content. The errors may be introduced, for example, at the time of manufacturing of the medium or when making an authorized copy of digital data. When authenticating digital media, the techniques disregard the erroneous error correction information contained within the medium and use the “raw” uncorrected data for authentication purposes.

Installation software executed from the media, for example, may compare the raw data of an access key stored on the medium to information supplied by a user, such as a license key or serial number. When the uncorrected data and the information match, the installation software may provide access to the content of the medium. Although the user can access the digital data contained within the medium, the intentional errors in the error correction information prevent the user from making working unauthorized copies of the digital medium. If an unauthorized copy of the digital medium is created, however, the conventional error correction schemes apply the corrupt error correction information to the digital data written to the unauthorized copy, thereby modifying the digital data. Consequently, the digital data on the unauthorized copy no longer operates in the same manner as the original digital medium.

In one embodiment, the invention is directed to a method for preventing unauthorized copying of digital media, whereupon receiving an input from a user, the system receives an access key from a medium. As discussed, the access key includes uncorrected data and associated error correction information having one or more errors. The system then controls access to the medium based on the input from the user and the uncorrected data of the access key.

In an additional embodiment, the invention is directed to a method for protecting digital media from unauthorized copying. An access key is generated, where the access key has uncorrected data and incorrect error correction information. The digital content of the media is then associated with the access key on a computer-readable medium, such as a CD or DVD.

Additional details of various embodiments are set forth in the accompanying drawings and the description below. Other features, objects and advantages will become apparent from the description and drawings, and from the claims.

### BRIEF DESCRIPTION OF THE DRAWINGS

FIG. 1 is a block diagram illustrating one embodiment of a computer system.

FIG. 2 is a block diagram illustrating one embodiment of digital medium according to the present subject matter.

FIG. 3 is a block diagram further illustrating the techniques for preventing unauthorized copying of a digital data.

FIG. 4 is a flowchart that provides an overview of the techniques for controlling access to digital data carried within a medium.

FIG. 5 is a flowchart further illustrating how the techniques affect the manner in which the digital content of a storage medium is copied from an authorized medium.

FIG. 6 is a flowchart illustrating one example of how the techniques may be applied to protect against unauthorized copying of digital data downloaded from a remote computer.

### DETAILED DESCRIPTION

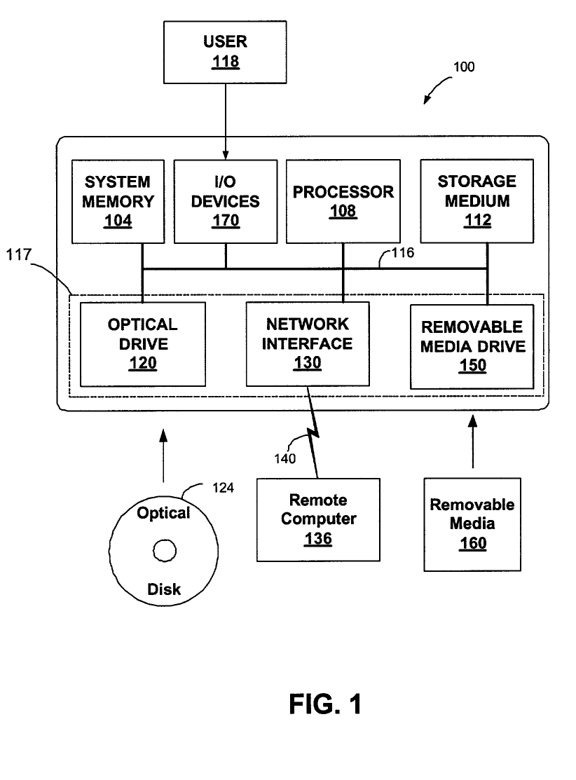

FIG. 1 is a block diagram of an exemplary computer system 100 illustrating techniques for preventing unauthorized copy of the digital medium. Computer system 100 includes a number of components interconnected by bus 116. Computer system 100 may include, for example, a processor 108 coupled to system memory 104 and storage medium 112.

Processor 108 may be, for example, a reduced instruction set computing (RISC) processor, a complex instruction set computing (CISC) processor, or variations of conventional RISC processors or CISC processors. Furthermore, processor 108 may be implemented in any number of different architectures including a pipelined architecture, a super-scalar architecture and a very long instruction word (VLIW) architecture having a number of instruction slots.

System memory 104 may be any computer storage medium including, for example, volatile and nonvolatile, removable and non-removable medium for storage of information such as processor-readable instructions, data structures, program modules, or other data. System memory 104 may comprise, for example, random access memory (RAM), read-only memory (ROM), EEPROM, flash memory, or the like. Storage medium 112 represents any internal medium for storing computer-readable instruction and data, such as an internal hard disk.

Computer system 100 further includes one or more data input/output (I/O) devices 117 that can be used either alone or in combination with the other data input/output devices to store or carry digital data. The digital data may be, for example, computer-executable instructions, such as software programs, or computer-readable data, including audio and video data.

Data I/O devices 117 can include, but are not limited to, an optical drive 120, a network interface 130, and removable media drive 150. Generally, data I/O devices 117 represent any device for interacting with removable medium such as CD-ROMs, digital versatile discs (DVD), or other optical storage, magnetic cassettes, magnetic tape, magnetic disk storage or other magnetic storage devices, or any other medium that can be used to store or carry the information for use by computer system 100.

Optical drive 120 includes hardware and software to read and write digital data from an optical disk 124. Network interface 130 receives and transmits data to and from one or more remote computers 136 or other resources through connection 140, which may be a local area network (LAN), wide area network (WAN), the Internet or the like. Furthermore, processor 108 may control network interface 130 to receive data from, and transmit data to, remote computer 136 through a wireless connection, where both the computer system 100 and the remote computer 136 include communication circuitry to receive and transmit data (e.g., cellular data transfer).

Drive 150 includes hardware and software to read and write data to and from a removable media 160. Examples of the removable media 160 include, but are not limited to, diskettes, tape or removable medium.

Computer system 100 also includes additional input/output (I/O) devices 170 and hardware for receiving commands and/or instructions entered through the I/O devices 170 to be carried out by the processor 108. Examples of the I/O devices 170 include a keyboard for conveying instructions from the user to the computer system 100. Alternatively, the I/O devices 170 can include any number of devices that allow for instructions to be conveyed to the computer system 100. Such devices can include pointing devices, such as a mouse, track pads or other devices suitable for positioning a cursor on a video display. Other I/O devices 170 are also possible.

In general, the techniques described herein facilitate content protection of digital medium by allowing computer system 100 to read and use originals or authorized copies of digital media, such as optical disk 124, removable media 160, or digital media received from remote computer 136. If user 118 attempts to make an unauthorized copy of the digital media, however, computer system 100 automatically corrupts the data content of the copy. Notably, the techniques are compatible with conventional error correction hardware and software that may be used with 1/O device 170. One advantage of the present subject matter, therefore, is that the content protection of the medium is accomplished using current medium drives and drive software. As a result, content protection of digital medium can be achieved using currently existing computer devices.

In order to prevent the unauthorized copying of digital media, errors are intentionally introduced within the error correction information during the production or generation of the original digital medium or any authorized copy thereof. The errors may be introduced, for example, at the time of manufacturing optical disk 124 or removable media 160, or at the time digital data is generated by remote computer 136 and transmitted to computer system 100 via connection 140. When authenticating digital media, computer system 100 may disregard the erroneous error correction information contained within the medium and use the “raw” uncorrected data for authentication purposes.

The errors may be introduced within error correction information corresponding to the stored content, such as a software application, or within a stored “access key” used to access the content. In one embodiment, the medium may store one or more access keys used to control access to digital data stored on, or carried within, the medium. The access key may, for example, be used to decompress and decrypt a software application stored on optical disk 124 and allow the user to install the software. An access key may contain a set of alpha-numeric characters that are typically stored as raw data and corresponding error correction information. In one embodiment, the digital medium includes a block (set) of access keys written to the digital medium during the manufacture of the digital medium. For example, 1 to N different keys could be written having intentional errors in the error correction information associated with each of the keys.

Installation software executed from the media, such as optical disk 124, may compare the raw data of an access key stored on the medium to information supplied by user 118. The software may, for example, compare the raw data to a license key or serial number. When the uncorrected data and the information match, the installation software may provide access to the content of the medium. The installation software may also further verify that the raw data of the medium key does not match the error correction information to confirm that the medium is an original.

Although user 118 can access the digital data contained within the medium, the intentional errors in the error correction information prevent user 118 from making a working unauthorized copy of the digital medium. The techniques may be used with any computer system that utilizes error correction, error detection, or both when reading, copying and writing data from a digital medium. Original and/or authorized copies of the content protected medium of the present invention can be read and used with most any drive. If an unauthorized copy of the digital medium is created, however, the error correction techniques applied by data I/O devices 117 corrupt the digital data written to the unauthorized copy. Consequently, the digital data on the unauthorized copy no longer operates in the same manner as the original digital medium.

More specifically, when user 118 attempts to copy an original storage media, the data I/O device 117 typically invokes error detection and error correction software, hardware or both. Data I/O device 117 copies digital data, such as a software application as well as the stored keys, to the unauthorized medium. During the process, the error correction hardware and software applies the error correction information to the raw data read from the original storage medium, and writes the results to the unauthorized medium. The keys, therefore, are modified based on the erroneous error correction information when copied from the original medium to the unauthorized medium, and are readily detectable by the installation program. In this manner, only original or authorized copies of the digital medium can be properly read and used with a computer system 100. The techniques can be used with any type of storage medium and corresponding device that applies error detection, error correction, or both.

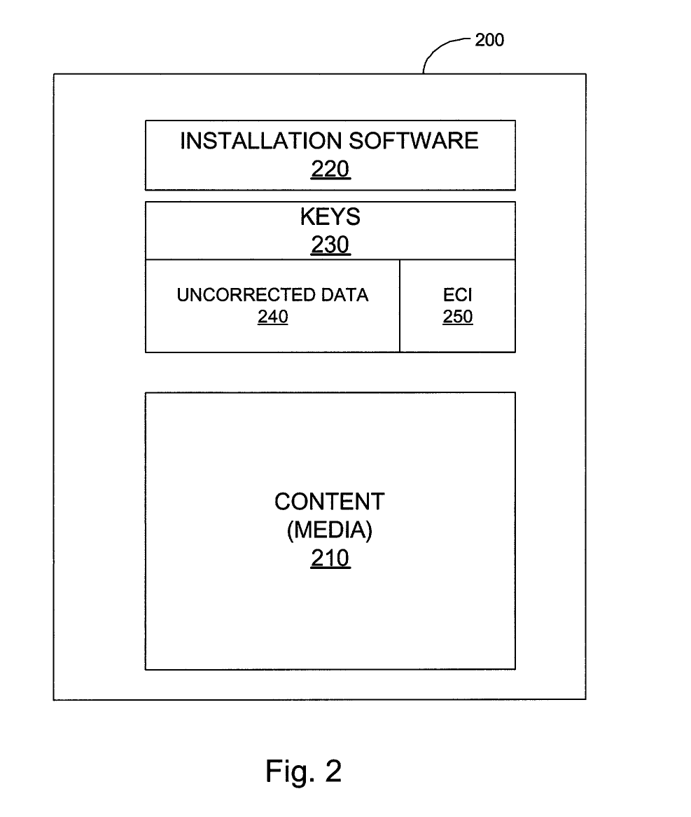

FIG. 2 is a block diagram illustrating an example storage medium 200. Storage medium 200 may comprise any one of the optical disk 124, remote computer system 136 and/or removable medium 160 or other storage medium. Storage medium 200 includes installation software 220 that directs and controls access to the content 210, which represents any digital data such as executable programs for controlling a computer system, audio data to generate audible sounds, such as music, video data for the display of images, and combinations of audio and video data for movies, video games and computer games.

The installation software 220 controls access to content 210 based on one or more keys 230. Each key 230 is stored as uncorrected (raw) data and associated error correction information 250. Error correction information 250 contains errors that were intentionally introduced at the time the storage medium 200 was created or generated. Examples of the error correction information include, but are not limited to, error correction code, cyclic redundancy code, and Cross Interleaved Reed-Solomon Code.

As described above, installation software 220 provides access to content 210 when input from user 118 matches the uncorrected data 240 of the keys 230. In one embodiment, the uncorrected data 240 of keys 230 is used to decrypt the digital content 210 contained within the medium 200. If user 118 attempts to copy the contents of storage medium 200, the error correction techniques applied by the device force uncorrected data 240 to be “corrected” using the error correction information 250 that contains the intentional errors. After being “corrected,” none of the keys 230 will match the input provided by user 118. As a result, the content medium 210 will no longer be accessible. The keys, for example, will be unable to decrypt or decompress the content 210. In addition, each key 230 may itself be encrypted to provide multiple levels of encryption protection. A user may decrypt the keys 230 through the use of a separate digital key, such as a digital certificate.

Media 210 typically includes raw data and error correction information. In one embodiment, errors are intentionally introduced within the error correction information of media 210. In this manner, media 210 itself is modified when copied, causing the content of the copied medium program to malfunction, or in the case of music or video, the sounds and/or will be distorted compared to the original. In an additional embodiment, the raw data can further include accurate error correction information capable of correcting any errors in the raw data. So, in addition to the false error correction information used to protect the raw data from unauthorized copying, the accurate error correction information can be used to correct actual errors in the raw data. As a result, the data is provided with multiple levels, or nested, error correction information, where a first level of error correction information contains intentional errors, as previously described, and a second level of accurate error correction information that can function to protect the integrity of the raw data by correcting actual errors that might occur in the raw data. Media 210 may be created at manufacturing time using a dedicated storage device having suitable hardware and software for writing installation software 220, content 210 and keys 230. In particular, the hardware and software may store each key 230 as uncorrected (raw) data and associated error correction information 250. In one embodiment, the hardware and software may comprise a chipset for generating the uncorrected data and faulty error correction information, as well as corresponding firmware for controlling the chipset.

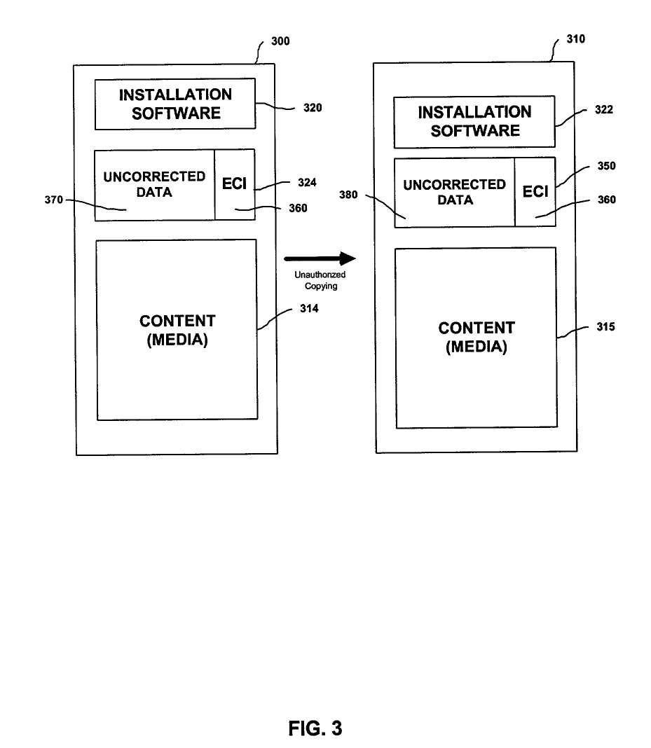

FIG. 3 is a block diagram further illustrating the techniques for preventing unauthorized copying of a digital data from an authorized medium 300 to an unauthorized medium 310. The authorized medium 300 can include any one of the optical disk 124, wireless connection 140 carrying data from remote computer system 136 and/or removable medium 160, as previously described. The authorized medium 300 includes medium content 314, installation software 320 and keys 324 for controlling access to the medium content 314. In the illustrated embodiment, the authorized medium 300 carries installation software 320, keys 324 and content 314, collectively referred to as digital data.

Copying storage medium 300 may be accomplished by using one or more data I/O device 117, under the control of computer system 100, to cause the digital data, or any portion thereof, of the authorized medium 300 to be copied to the unauthorized medium 310. In transferring the digital data of the authorized medium 300 to the unauthorized medium 310, the introduction of erroneous error correction information causes modification to the digital data written to storage medium 310.

In the present situation, the entire digital data content of the authorized medium 300 is copied to the unauthorized medium 310. In one embodiment, this allows for the content 314 to be duplicated to the unauthorized medium 310 as content 315 without modification. Similarly, installation software 320 is also copied over to the unauthorized medium 310 as installation software 322 without modification. Keys 324 are copied over to the unauthorized medium 310 as keys 350; however, keys 324 are modified due to the incorrect error correction information (360) of the authorized medium 300.

Notably, the content of the authorized medium 300 is being copied under the control of the computer system 100. In other words, installation software 320 is not typically invoked. During the copying process, computer system 100 and the corresponding firmware, device drivers and/or hardware of data I/O devices 117 apply error correction information 360 to the uncorrected data 370 of keys 324. Examples of the error correction performed on the keys include, but are not limited to, error correction code, cyclic redundancy code, and Cross Interleaved Reed-Solomon Code.

The resulting data keys 380 are written to the unauthorized medium 310 as keys 350, including the “corrected” raw data 380 and new error correction information 360. In this manner, error correction information 360 no longer includes errors, as does the original, and is accurate according to uncorrected data 380. When a user tries to use the unauthorized medium 310, installation software 322 denies access to content 315 on the unauthorized medium 310, as the data keys 380 no longer match the input received from a user.

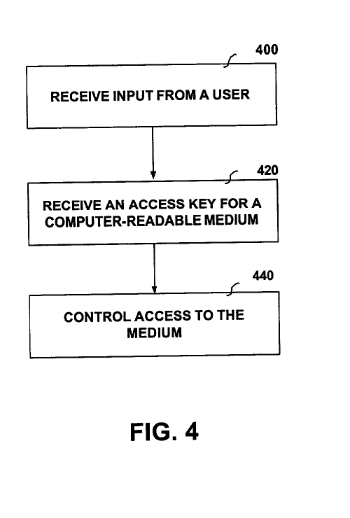

FIG. 4 is a flowchart that provides an overview of the techniques for controlling access to digital data carried within a medium. Generally, FIG. 4 illustrates one way in which a user gains access to a digital medium having content protection of the present invention. The embodiment of FIG. 4 can be used generically to describe a user accessing digital data from any number of locations. For example, the method of FIG. 4 is useful in describing access to digital medium on a CD-ROM or a DVD. Alternatively, the method of FIG. 4 is useful in describing access to digital data that is being transmitted between a first and a second computer system. Examples of this situation include, but are not limited to, a user accessing and downloading digital data from a computer over a network such as the Internet. Other systems for transferring and/or transmitting the data are also possible. For exemplary purposes, reference is made to FIG. 1.

Initially, a software module, such as installation software carried on the medium or a device driver loaded within computer system 100, receives input from user 118 (400). In one embodiment, the input from user 118 is an authorization key for accessing digital medium. For example, the authorization key could be a string of symbols (letters, numbers, etc.) that represent a license code for the individual piece of digital data. This authorization key corresponds to at least one medium key associated with the digital data, and can be used to allow access to the content of the digital data.

Upon receiving the input from user 118, computer system 100 retrieves a key from the medium, such as optical disk 124, connection 140 or removable media 160 (420). In one embodiment, the computing system retrieves the key from the medium under the control of software instructions from the medium itself, e.g., an installation program. Typically the installation program reads data from the storage medium, typically by interacting with a device driver loaded within computer system 100. In particular, the installation program may direct the device driver to return the access key, as well as the uncorrected data and error correction information read from the storage medium. The uncorrected data may include uncorrected data and associated error correction information having one or more errors, as previously discussed. In other words, the installation software of the medium is used to invoke a device driver of the storage device to read the uncorrected data from the medium, without application of the corresponding error correction information. As discussed, the access keys from the medium include error correction information having intentionally incorrect values.

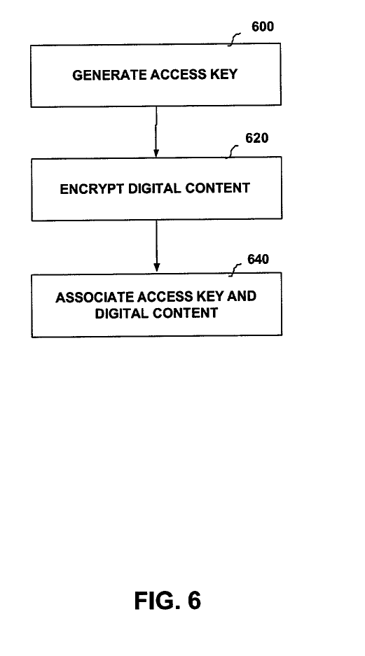

In one embodiment, the techniques make use of a unique identifier for each medium to further prevent unauthorized copying. The unique identifier may be generated at manufacturing time, or when data is first recorded on the media. One method of generating the unique identifier is to generate a random number, possibly based on the current time in milliseconds in combination with an Ethernet address for the generating computer. Another method includes licensing a block of unique numbers from a standard organization. The random number may be repeated in various locations on the storage medium and may be used to point into the table of medium keys to select a valid key. This embodiment, as described in detail below with reference to FIG. 6, may be particularly useful for digital data downloaded from a remote computer 136.

Computer system 100 controls access to the medium based on the input received from user 118, the uncorrected data of the key read from the medium, and the unique identifier read from the storage medium itself (440). For example, computer system 100 may allow access to the content of the medium when the user input matches the uncorrected data of the stored key. In another embodiment, computer system 100 may apply a hashing function to the random number and the selected key using a one-way function to generate a second key for use by encryption software to read the content on the disc, thus requiring both for access to the stored content. In either case, access to the content of the medium may include decompressing and/or decrypting digital content contained within the medium based on the uncorrected data of the key and/or the input from the user.

Once user 118 has access to the content of the medium, the user can, for example, install one or more software applications from the medium onto the computing system 100. Alternatively, once user 118 has access to the content of the medium, the user can instruct computer system 100 to execute one or more software applications from the medium. Examples of installing, executing and/or accessing software applications or other data include, but are not limited to, word processing and storage functions, data processing and storage functions, games, audio data for producing an audio output based on content stored on the medium, and/or video data for producing a video output based on content stored on the medium.

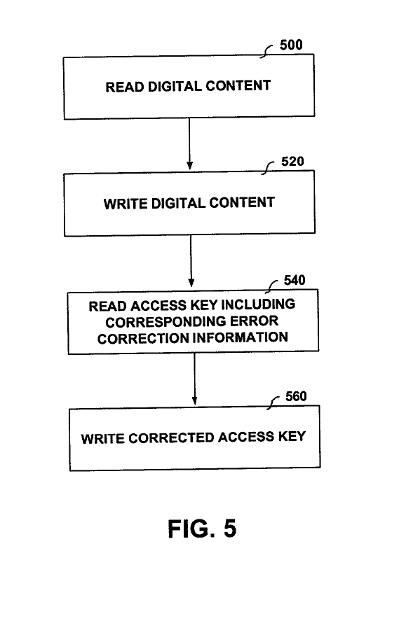

FIG. 5 is a flowchart further illustrating how the techniques affect the manner in which the digital content of a storage medium is copied from an authorized medium, such as an original, to a second, unauthorized storage medium. For exemplary purposes, reference is again made to FIG. 1.

In copying the digital content of the medium, computing system 100 reads the digital content of the authorized medium (500). In one embodiment, the digital content of the storage medium can include, but is not limited to, the medium content, the installation software and the medium keys stored on the storage medium. Computer system 100 writes the digital content of the authorized medium to the second medium (520) in creating the unauthorized medium.

As the digital content is copied from the authorized medium to the second medium, computer system 100 reads the access keys from the authorized medium (540). As previously discussed, the access keys include error correction information that has been intentionally corrupted. When the access keys are copied to the second medium (560), computing system 100 applies the corrupted error correction information to the access keys. As a result, the second storage medium includes the duplicates of the content and installation software from the authorized medium. The second storage medium also includes second access keys that have been “corrected” by application of the corrupt error correction information. Consequently, the second access keys no longer correspond to any access key known to the user. As such, the user will not be able to access the medium content of the second storage medium (the unauthorized medium) using the access key that allowed access to the medium content on the authorized medium.

In one embodiment, the storage medium comprises multiple access keys stored at various locations. This configuration may be useful in the event one area of the medium becomes physically damaged. Computer system 100 may read and compare multiple access keys to the input provided by the user, and provide access to the storage medium when at least one of the access keys match the user input. In this manner, computer system 100 may selectively use one or more access keys read from the medium.

FIG. 6 is a flowchart illustrating one example of how the techniques may be applied to protect against unauthorized copying of digital data, such as software applications, video, or audio data, that is downloaded from a remote computer. In particular, the embodiment is useful in the context where user 118 downloads digital data from remote computer 136 and stores the digital data on medium, such as optical disk 124 or removable media 160.

Upon receiving a download request, computer system 100 and remote computer 136 cooperate to generate an encryption key for the digital data to be downloaded (600). More specifically, software modules installed on computer system 100 read one or more keys from a current storage medium loaded within one of the data I/O devices 117, and upload the access key for use as an encryption key. In one embodiment, the software modules also use a unique number in conjunction with the access key. The software module may, as described above, generate a random number or may read a random number from the storage medium in the event the random number was generated at manufacturing. The software modules may use the random number to select an access key from a set of access keys stored on the current storage medium, and upload the selected access key to remote computer 136 for use in the encryption process.

Upon receiving the access key from computer system 100, remote computer 136 encrypts the digital data, such as an MP3 audio file, and communicates the encrypted digital data to computer system 100 (620). Upon receiving the encrypted digital data, remote computer 100 writes the digital data to the storage medium used to generate the encryption key (640).

In this manner, the digital data stored on the storage medium may only be accessed using an encryption key generated from the unique identifier and one or more access keys stored on the storage medium. As a result, if the medium is copied, the access keys on the unauthorized copy will be modified due to the corrupt error correction information. Consequently, the user will be unable to decrypt the digital data stored on the unauthorized copy. In other words, the combination of the updated keys and the unique number on the new storage medium will generate a different encryption key; a key that will not unlock the content on the unauthorized storage medium.

A number of implementations and embodiments of the invention have been described. Nevertheless, it is understood that various modifications can be made without departing from the spirit and scope of the invention. For example, the techniques described herein could be utilized in a variety of applications including, for example, wireless debit transactions. A user may use an apparatus, such as a cellular phone or a personal data assistant (PDA) to debit monies from an account. Examples of such accounts include, but are not limited to, personal banking accounts, business banking accounts, or other accounts for which the individual has authority to debit monies. At the time of the transaction, the apparatus may communicate with an apparatus of a corresponding merchant and transmit account information and user information, along with a unique encrypt key in order to access the account and user information. The encryption key is transmitted with the false error correction information. Any non-compliant devices will not appropriately handle the false error correction information. As a result, the encryption key would be “corrected” rendering the key useless for the transaction. However, if a licensed device were used, the error correction code information for the transmitted key would be overlooked, and the key would be compared in the process of authorizing the transaction. These and other embodiments are within the scope of the following claims.

What is claimed is:

1. A method, comprising:
receiving input from a user;
receiving an access key from a medium, wherein the access key includes uncorrected data and associated error correction information having one or more errors; and
controlling access to the medium based on the input and the uncorrected data.

2. The method of claim 1, wherein controlling access to the medium comprises:
invoking a device driver of a storage device to read the uncorrected data from the medium without modification from application of the error correction information; and
comparing the uncorrected data and the input.

3. The method of claim 1, wherein controlling access to the medium includes installing a software application from the medium onto a computing system.

4. The method of claim 1, wherein controlling access to the medium includes executing a software application from the medium.

5. The method of claim 1, wherein controlling access to the medium includes:
copying content from the medium to a second medium;
applying the error correction information to the uncorrected data to produce a second access key; and
copying the second access key to the second medium.

6. The method of claim 1, wherein controlling access to the medium includes producing an audio output based on content stored on the medium.

7. The method of claim 1, wherein receiving the access key includes:
receiving a first access key and a second access key from the medium, where the first and second access keys each include uncorrected data;
comparing the uncorrected data of the first access key to the uncorrected data of the second access key; and
selectively using the first access key based on the comparison.

8. The method of claim 1, wherein the error correction information includes error correction information selected from an error correction code, a cyclic redundancy code, and a Cross Interleaved Reed-Solomon Code.

9. The method of claim 1, wherein controlling access to the medium comprises decrypting digital content contained within the medium based on the uncorrected data and the input.

10. The method of claim 9, wherein the digital content comprises at least one of a software application, audio data, or video data.

11. The method of claim 1, wherein receiving the access key includes decrypting the access key.

12. The method of claim 1, further including selecting the access key from a plurality of access keys, where each of the access keys includes data and associated error correction information having one or more errors.

13. The method of claim 12, where selecting the access key includes:
assigning a random number to the medium, wherein the random number is uniquely associated with the medium;
selecting the access key from the plurality of access keys based on the random number;
generating a hash value from the random number and the selected access key; and
decrypting content of the medium using the hash value.

14. The method of claim 1, wherein the uncorrected data includes accurate error correction information for the uncorrected data.

15. A computer-readable medium comprising instructions for causing a programmable processor to:
receive input from a user;
read an access key from a medium, wherein the access key includes uncorrected data and associated error correction information; and
control access to the medium based on the input and the uncorrected data.

16. The computer-readable medium of claim 15, wherein the instructions cause the processor to invoke a device driver of a storage device to read the uncorrected data from the medium without modification based on the error correction information, and to compare the uncorrected data and the input.

17. The computer-readable medium of claim 15, wherein the instructions cause the processor to install a software application from the medium onto a computing system based on the input and the uncorrected data.

18. The computer-readable medium of claim 15, wherein the instructions cause the processor to execute a software application from the medium based on the input and the uncorrected data.

19. The computer-readable medium of claim 15, wherein the instructions cause the processor to produce an audio output from content stored on the medium based on the input and the uncorrected data.

20. The computer-readable medium of claim 15, wherein the error correction information includes error correction information selected from an error correction code, a cyclic redundancy code, and a Cross Interleaved Reed-Solomon Code.

21. The computer-readable medium of claim 15, wherein the instructions cause the processor to decrypt content from the medium based on the uncorrected data set.

22. The computer-readable medium of claim 15, wherein the uncorrected data includes accurate error correction information for the uncorrected data, and where the processor corrects errors in the uncorrected data with the accurate error correction information.

23. A computer-readable medium, comprising:
an access key having uncorrected data and associated error correction information having one or more errors;
digital content; and
an executable software application to control access to digital content based on the uncorrected data.

24. The data storage device of claim 23, wherein the digital content comprises a software program.

25. The data storage device of claim 23, wherein the digital content is selected from one of an audio file and a video file.

26. The data storage device of claim 23, wherein the error correction information includes an incorrect cyclic redundancy code.

27. The data storage device of claim 23, wherein the error correction information causes the uncorrected data to be changed when the computer-readable medium is copied.

28. The data storage device of claim 23, wherein the uncorrected data includes accurate error correction information that corrects errors in the uncorrected data.

29. A method, comprising:
generating an access key having uncorrected data and incorrect error correction information; and
associating digital content and the access key on a computer-readable medium.

30. The method of claim 29, wherein associating content and the access key comprises communicating the digital content and the access key through a transmission medium.

31. The method of claim 29, wherein associating the content and the access key comprises storing the digital content and the access key on a storage medium.

32. The method of claim 29, further including applying the incorrect error correction information to the uncorrected data when the access key is copied from the medium to a second medium.

33. The method of claim 29, further comprising:
receiving input from a user;
generating an encryption key based on the input and the access key;
encrypting the digital content based on the encryption key; and
associating the encrypted digital content with the access key.

34. The method of claim 33, wherein associating the encrypted digital content with the access key comprises communicating the encrypted digital content and the access key through a transmission medium.

35. The method of claim 29, wherein the digital content includes an audio file.

36. The method of claim 29, wherein the digital content includes an application file.

37. The method of claim 29, wherein generating the access key includes generating uncorrected data having accurate error correction information.
